(19) United States
(12) Patent Application Publication
(10) Pub. No.: US 2026/0240065 A1
(43) Pub. Date: Aug. 20, 2026

(54) Tool Bar Assemblies For Use With Agricultural Implements, And Related Methods

(71) Applicant: MONSANTO TECHNOLOGY LLC, Saint Louis, MO (US)

(72) Inventors: Kenton HILKE, Saint Peters, MO (US); Paul Lee MISKELL, Collinsville, IL (US); Timothy Edward REITZ, Saint Louis, MO (US); Andrew David THIELEN, Scranton, IA (US); Laura WHITTLE, Saint Louis, MO (US)

(21) Appl. No.: 19/164,939

(22) PCT Filed: Mar. 15, 2024
(86) PCT No.: PCT/US2024/020173

§ 371 Date: Sep. 12, 2025

Related U.S. Application Data
(60) Provisional application No. 63/453,064, filed on Mar. 17, 2023.

(51) Int. Cl. A01B 63/30; A01B 63/24

(52) U.S. Cl. CPC A01B 63/30; A01B 63/245

(57) ABSTRACT

The present disclosure generally relate to tool bar assemblies for agricultural implements. In one example embodiment, a tool bar assembly includes a carrier configured to coupled to a row unit of an agricultural implement, a rail defining a channel configured to receive the carrier and guide movement of the carrier along the rail, an insert removably coupled to the rail within the channel of the rail, and a support removeably coupled to the rail outside of the channel in a position generally opposing the insert.

### CROSS-REFERENCE TO RELATED APPLICATION

This application claims the benefit of, and priority to, U.S. Provisional Application No. 63/453,064 filed on Mar. 17, 2023. The entire disclosure of the above application is incorporated herein by reference.

### FIELD

The present disclosure generally relates to tool bar assemblies for use with agricultural implements (e.g., planters for use in planting seeds in fields, sprayers for applying treatments to fields, etc.), and to methods of using the tool bar assemblies (e.g., modifying existing tool bars to include the tool bar assemblies, etc.).

### BACKGROUND

This section provides background information related to the present disclosure which is not necessarily prior art.

Growers often cultivate thousands or tens of thousands of plots of numerous different types of seeds in order to test/analyze different genotypic and/or phenotypic traits of the seeds and/or selected treatments applied thereto. In so doing, fields can comprise multiple such plots, and each of the plots may be planted with different types of the seeds in multiple rows. As an example, a grower may plant, using a planter, a first plot in a given field with a first type of seed in order to test/analyze the seed. The grower may then change the seed type at the planter to a second type of seed and proceed in the field to plant the second type of seed in order to test/analyze the second type of seed. In some instances, different row spacings may be used by the planter for the different types of the seeds being planted.

### SUMMARY

This section provides a general summary of the disclosure, and is not a comprehensive disclosure of its full scope or all of its features.

Example embodiments of the present disclosure generally relate to tool bar assemblies for agricultural implements. In one example embodiment, a tool bar assembly generally includes: a carrier configured to coupled to a row unit of an agricultural implement; a rail defining a channel configured to receive the carrier and guide movement of the carrier along the rail (e.g., via a drive mechanism, etc.); an insert removably coupled to the rail within the channel of the rail; and a support removeably coupled to the rail outside of the channel in a position generally opposing the insert.

Example embodiments of the present disclosure also generally relate to methods of retrofitting tool bars of agricultural implements. In one example embodiment, such a method generally includes: positioning an insert within a channel of a rail of the tool bar of the agricultural implement, along a sidewall of the rail; positioning a support along the sidewall of the rail, in a position outside of the channel and generally opposing the insert so that the sidewall of the rail is positioned generally between the insert and the support; and coupling the insert to the support.

Example embodiments of the present disclosure also generally relate to kits for use in retrofitting tool bars of agricultural implements. In one example embodiment, such a kit generally includes: an insert configured to removably couple to a rail of the agricultural implement within a channel of the rail and along a sidewall of the rail; and a support configured to removeably couple to the rail outside of the channel, along the sidewall of the rail, in a position generally opposing the insert and with the sidewall of the rail generally between the insert and the support.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example embodiment of a planter including a tool bar assembly of the present disclosure, with the planter shown coupled to a tractor configured to move (e.g., pull, etc.) the planter;

FIG. 2 is a perspective view of the planter of FIG. 1 shown apart from the tractor;

FIG. 3 is a side view of the planter of FIG. 1;

FIG. 4 is an enlarged, fragmentary perspective view of the planter of FIG. 1;

FIG. 5 is an enlarged, fragmentary perspective view of the tool bar assembly of the planter of FIG. 1;

FIG. 6 a perspective view of the tool bar assembly of the planter of FIG. 1, with carriages of the tool bar assembly removed;

FIG. 7 is an enlarged, fragmentary exploded view of the tool bar assembly of the planter of FIG. 6;

FIG. 8 is a side elevation view of the tool bar assembly of FIG. 6;

FIG. 9 is a side elevation view of a carrier of the tool bar assembly of the planter of FIG. 1;

FIG. 10 is a perspective view of the carrier of FIG. 9;

FIG. 11 is a perspective view of an example embodiment of an agricultural implement including a tool bar assembly of the present disclosure, with the agricultural implement shown coupled to a tractor configured to move (e.g., pull, etc.) the agricultural implement; and FIGS. 12-14 are fragmentary perspective views of a drive mechanism of the agricultural implement of FIG. 11, configured to drive (e.g., mechanically, automatically, etc.) movement of row units of the agricultural implement relative to each other.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

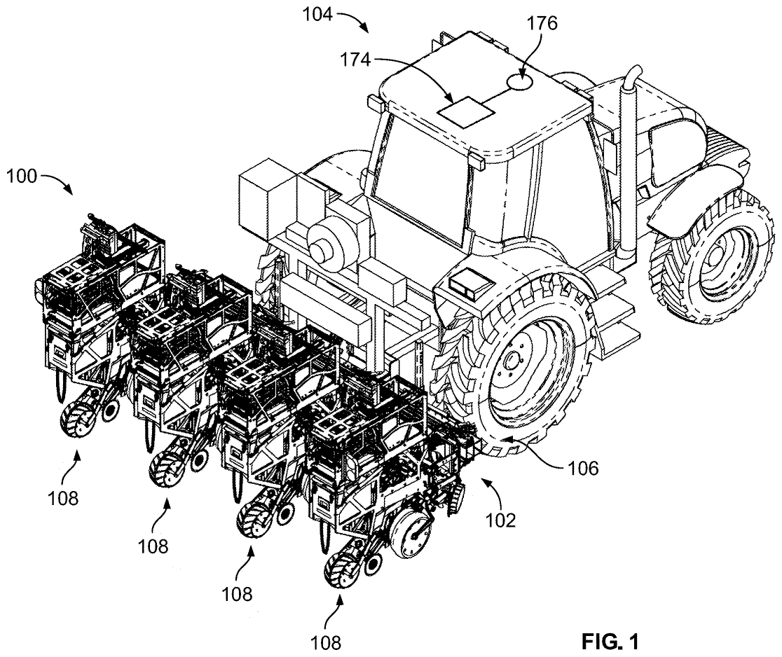

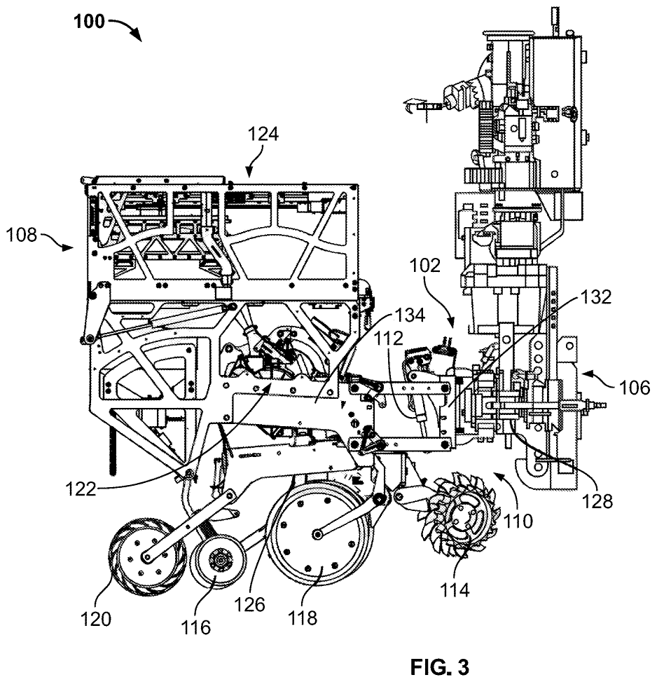

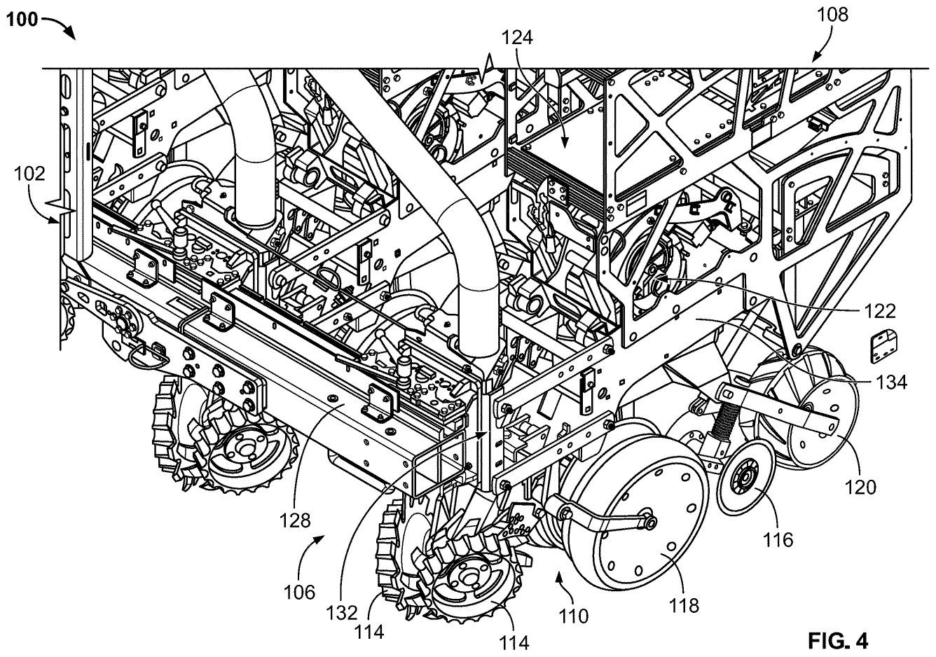

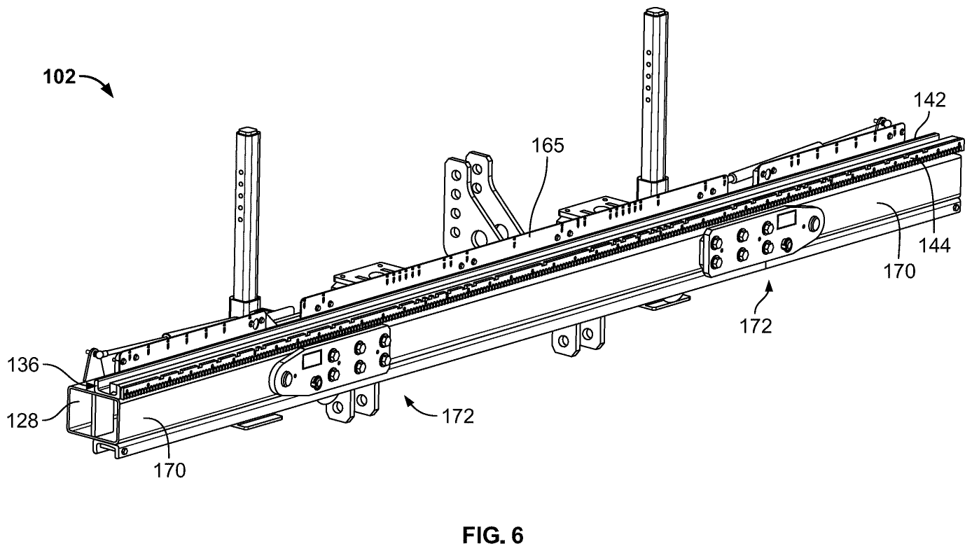

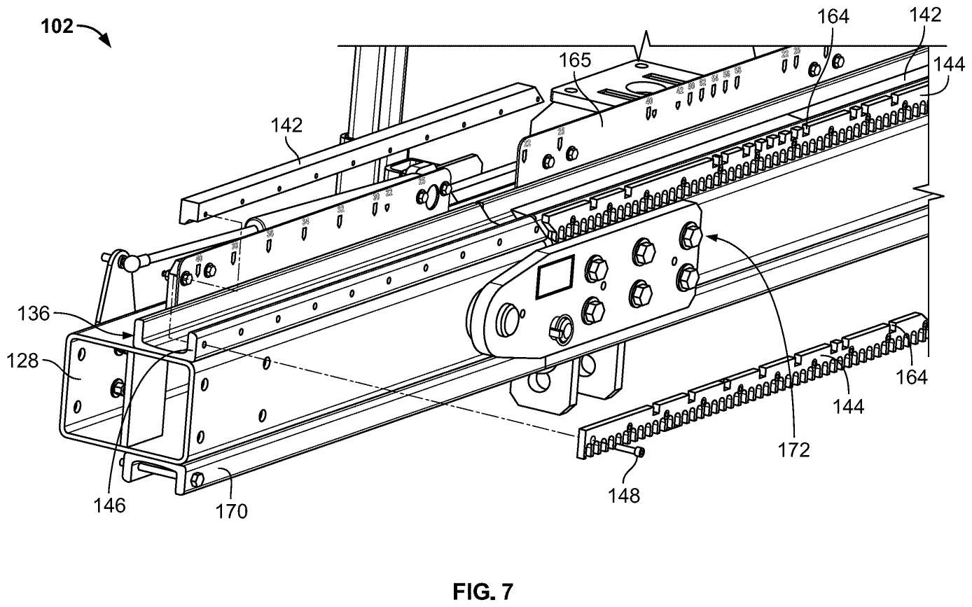

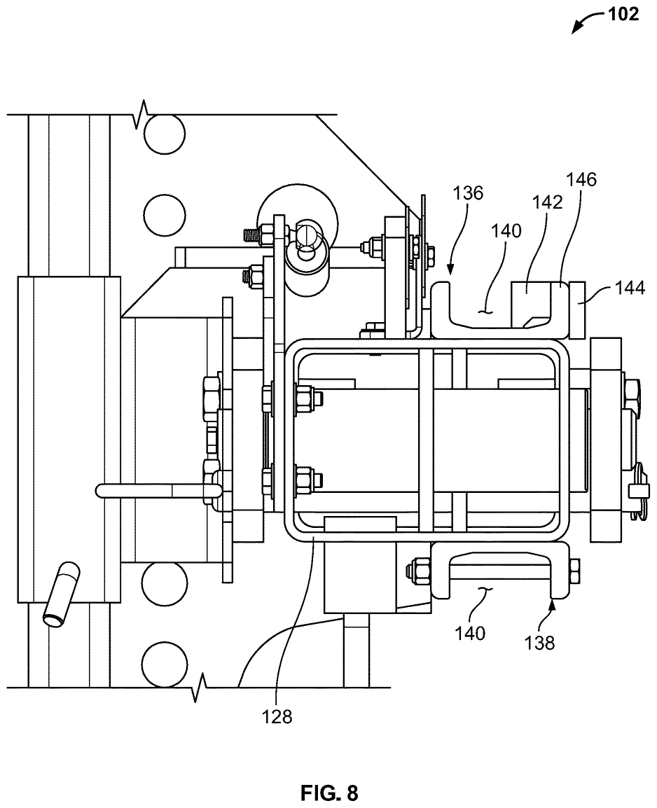

FIGS. 1-10 illustrate an example embodiment of a multi-row planter 100 (broadly, an agricultural implement) for use in planting seeds in a field (e.g., as part of a plot in the field, etc.), and having a tool bar assembly 102 including one or more aspects of the present disclosure. The tool bar assembly 102 may be installed to (or included in) the planter 100 as part of an upgrade or update to an existing tool bar of the planter 100 (e.g., as a retrofit to update or upgrade the tool bar with components that can be replaced if/when worn out, etc.), or the tool bar assembly 102 may be included as part of, or incorporated into, an original tool bar of the planter 100. In addition, while the following description of the tool bar assembly 102 is provided in the context of the planter 100, it should be appreciated that the tool bar assembly 102 may be used in and/or applied to agricultural implements other than planters in other example embodiments (e.g., sprayers, etc.).

As shown in FIG. 1, the planter 100 (including the tool bar assembly 102 of the present disclosure) may be towed or transported on a trailer to a field/plot where it is to be used. In the field/plot, then, in this example embodiment, the planter 100 may be adapted to be towed by a conventional tractor 104 for planting the seeds. However, in various other embodiments, the planter 100 may be incorporated into a conventional over the road vehicle or other vehicle that could be driven across fields/plots for planting seeds.

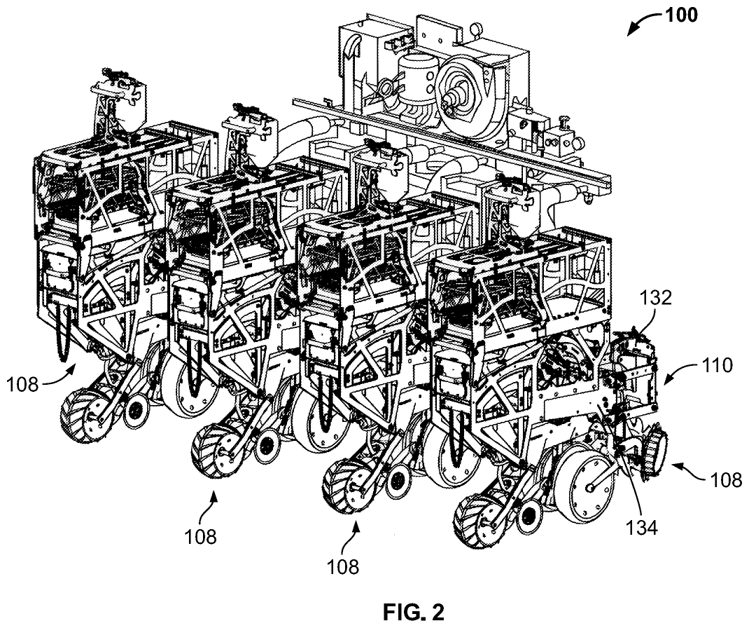

With additional reference to FIGS. 2-4, the planter 100 generally includes a frame 106 supporting multiple planting units 108 (broadly, row units). And, the planting units 108 are configured to plant seeds as desired in a field/plot. In the illustrated embodiment, the planting units 108 are configured to plant any desired types of seeds (e.g., without limitation, corn, soybeans, etc.). In various embodiments, one or more of the planting units 108 may be adapted to handle more than one type of seed, or may be quickly converted to handle different types of seeds (such that different ones of the planting units 108 may plant different seeds and/or such that the planting units 108 may switch between types of seeds being planting, for example, while planting (e.g., “on the fly”, without stopping, etc.)). Also in the illustrated embodiment, the planter 100 includes four planting units 108. And, each of the planting units 108 is substantially identical in structure and functionality. As such, for clarity and simplicity, a single one of the planting units 108 is described next for reference, with it understood that such description equally applies to each of the other planting units 108 of the planter 100. That said, in other embodiments, the planter 100 may include more than or fewer than four planting units within the scope of the present disclosure (e.g., two planting units, six planting units, eight planting units, sixteen planting units, twenty planting units, etc.).

The example planting unit 108 includes a linkage assembly 110, having an actuator 112 configured (e.g., structured, operable, etc.) to apply lifting and/or downward force on the planting unit 108 relative to the frame 106 (e.g., during planting, etc.). The planting unit 108 also includes a pair of row cleaners (each indicated at 114) configured to clear a path for planting, and a pair of furrow opening discs (each indicated at 116) configured (in conjunction with the downward force applied by the linkage assembly 110) to open a V-shaped trench, or furrow, in the soil in the given field (into which seeds are then dispensed by the planting unit 108). The planting unit 108 additionally includes a pair of gauge wheels 118 configured to control a depth of the furrow formed by the opening discs 116. In particular, a height of the gauge wheels 118 relative to the opening discs 116 controls the depth of the furrow. Further, the planting unit 108 includes a closing wheel 120 configured to close the furrow, after the seeds are deposited therein, and to cover the planted seeds.

The planting unit 108 also includes a seed meter 122 in communication with onboard seed storage 124. In this embodiment, the seed meter 122 is disposed generally below the seed storage 124. As such, based on this positioning, gravity may be used to facilitate movement of the seeds from the seed storage 124 to the seed meter 122 (however, air, etc. may also be used as desired in other embodiments). The seed meter 122 is configured to receive seeds from the seed storage 124 and to dispense the received seeds into the furrow created by the planting unit 108 (i.e., created by the furrow opening discs 116) (via a planting tube 126 in communication with the seed meter 122). In particular, the seed meter 122 is configured to receive seeds from the seed storage 124, meter the seeds, and then deposit (i.e., plant) a particular number (and/or volume) of the seeds into the furrow via the planting tube 126.

The planting units 108 of the planter 100 are each individually adjustable relative to the frame 106, via the tool bar assembly 102. As such, a relative spacing between the planting units 108 may be changed (e.g., to allow for compact travel, to adjust spacing between the planting units 108 during planting (e.g., on the fly, etc.) to thereby adjust spacing between rows of seeds planted in a field, etc.).

For example, in the illustrated embodiment, the tool bar assembly 102 is configured to facilitate, accommodate, etc. individual sliding movement of each the planting units 108 along a tool bar 128 of the planter 100 relative to the frame 106. In connection therewith, the tool bar assembly 102 includes, generally, the tool bar 128 associated with the frame 106 of the planter 100 (e.g., coupled to the frame 106 of the planter 100, formed as part of the frame 106 of the planter 100, etc.) and carriers 130 (or carriages) associated each of the planting units 108. Each of the planting units 108 comprises a mounting plate 132 and a frame 134 that is coupled to the mounting plate 132 by the linkage assembly 110. The carriers 130, then, are each configured to couple to a respective one of the planting units 108 at the mounting plate 132 (via mechanical fasteners, welds, etc.). In turn, the carriers 130 are configured to couple to the tool bar 128, to thereby support the planting units 108 on the tool bar 128 and allow the planting units 108 to slide along the tool bar 128 relative to the frame 106 of the planter 100.

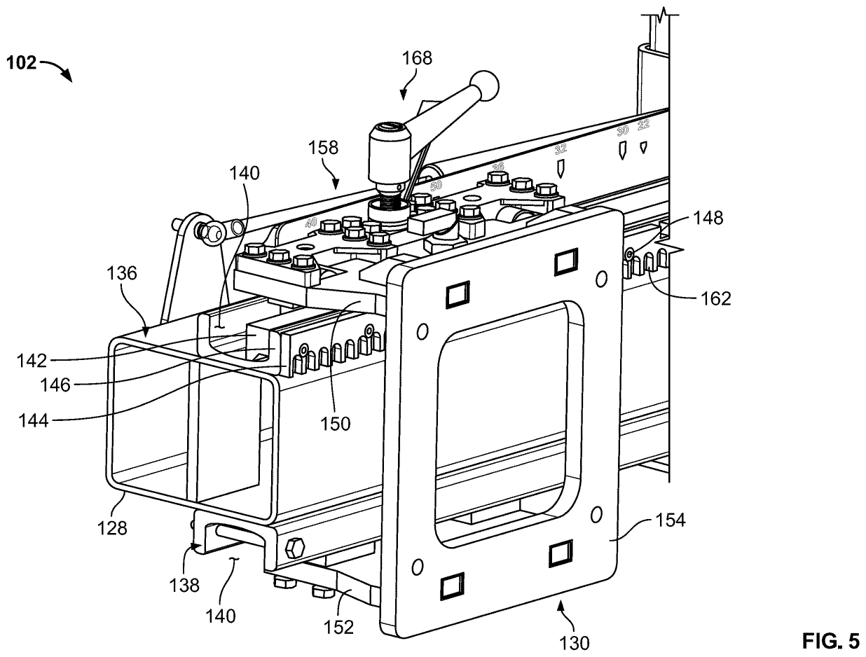

Referring now to FIGS. 5-8, in the illustrated embodiment, the tool bar 128 of the planter 100 includes a beam (e.g., a box beam, etc.) extending generally transverse relative to the planting units 108. Upper and lower tracks 136, 138 (e.g., rails, et.) are provided on upper and lower surfaces of the tool bar 128 (e.g., such that the tool bar 128 includes the upper and lower tracks 136, 138, etc.). The tracks 136, 138 may be formed as part of the tool bar 128, or they may be separate from the tool bar 128 and coupled thereto. For example, the tracks 136, 138 may include upwardly and downwardly facing sections of a C-channel coupled to the tool bar 128, etc. In any case, the tracks 136, 138 each define a channel 140 for receiving the carriers 130 therein and supporting sliding movement of the carriers 130 along the tool bar 128.

The tool bar assembly 102 also includes an insert 142 disposed within the upper track 136 (or rail) of the tool bar 128 (e.g., within the channel 140 defined by the upper track 136, etc.), and a support 144 disposed opposite the insert 142 generally outside of the upper track 136 (e.g., outside of the channel 140 defined by the upper track 136, etc.). In particular in this embodiment, the upper track 136 of the tool bar 128 includes a sidewall 146 forming part of the channel 140 thereof. The insert 142 is positioned along the sidewall 146 generally within the channel 140, extending substantially along a length of the channel 140 (and, thus, generally along a length of the tool bar 128). And, the support 144 is positioned along the sidewall 146 generally outside of the channel 140 and generally opposing the insert 142. In this manner, the support 144 is arranged generally parallel to the insert 142 and, similar to the insert 142, extends substantially along a length of the channel 140 defined by the upper track 136. Fasteners 148 couple the insert 142 and the support 144 together, with the sidewall 146 of the upper track 136 positioned therebetween. For instance, the fasteners 148 extend through the sidewall 146 of the upper track 136 and couple the insert 142 and the support 144 thereto (and generally to each other).

The lower track 138 of the tool bar 128 does not include an insert or support in the illustrated embodiment (e.g., only the upper track 136 is fitted with the insert 142 and the support 144 of the tool bar assembly 102 in the illustrated embodiment, etc.). As such, in this embodiment, a width dimension of the channel 140 defined by the upper track 136 is generally smaller (or narrower) than a width dimension defined by the channel 140 of the lower track 138. However, it should be appreciated that the lower track 138 may include an insert and support in other embodiments (such that both the upper track 136 and the lower track 138 include an insert and a support, or such that only the lower track 138 includes an insert and support).

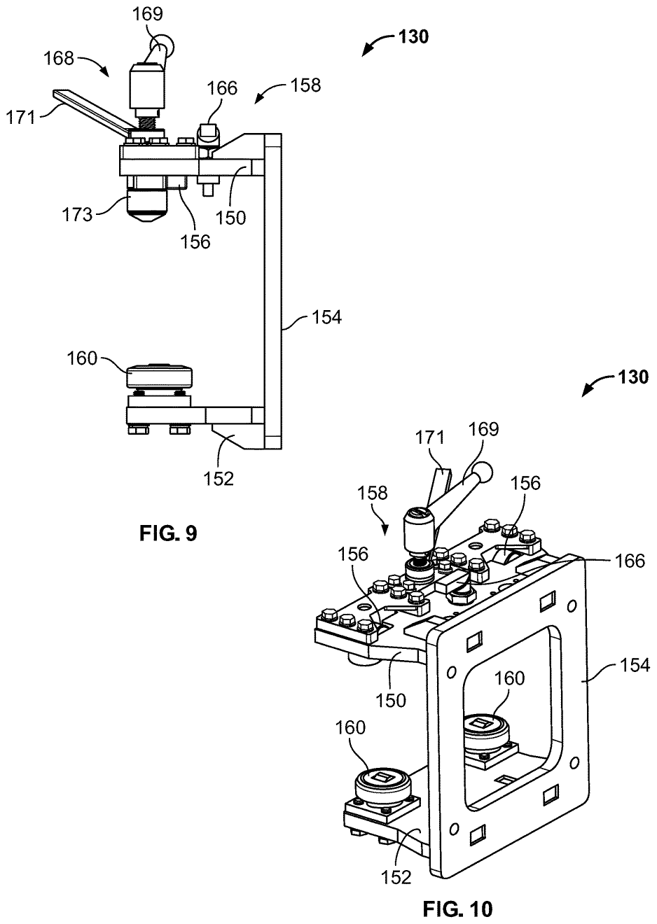

With additional reference to FIGS. 9-10, each of the carriers 130 comprises upper and lower members 150, 152, and a plate 154 extending between the upper and lower members 150, 152. Vertical rollers 156 (e.g., two spaced apart vertical rollers 156 in the illustrated embodiment, etc.) (e.g., vertically oriented rollers having generally horizontally arranged rotational axes, etc.) are coupled to the upper member 150, for example, as part of a bearing plate 158 coupled to the upper member 150, etc. (e.g., via fasteners, whereby the baring plate 158 may be added to existing carriers having upper horizontal rollers as part of a retrofit; etc.). The rollers 156 are configured to position generally within the channel 140 of the upper track 136 and slide therein generally along/against the insert 142 within the upper track 136 (e.g., along an upper surface of the insert 142, etc.). Horizontal rollers 160 (e.g., two spaced apart horizontal rollers 160 in the illustrated embodiment, etc.) (e.g., horizontally oriented rollers having generally vertically arranged rotational axes, etc.) are coupled to the lower member 152, and are configured to fit within the channel 140 of the lower track 138 and slide therein along the lower track 138. In this way, the carriers 130 are slidably coupled to (e.g., slidably mounted in, etc.) the tracks 136, 138 to slide (broadly, move) along the tool bar 128. And, the plate extending between the upper and lower members 150, 152 defines a mounting surface for coupling the carrier 130 (e.g., the mounting plate 132 of the carrier 130 as discussed above, etc.) to a respective one of the planting units 108. The carriers 130 can then be used, via the tool bar assembly 102, again, to control, adjust, etc. the spacing between the planting units 108 (e.g., manually, automatically, etc.) as desired.

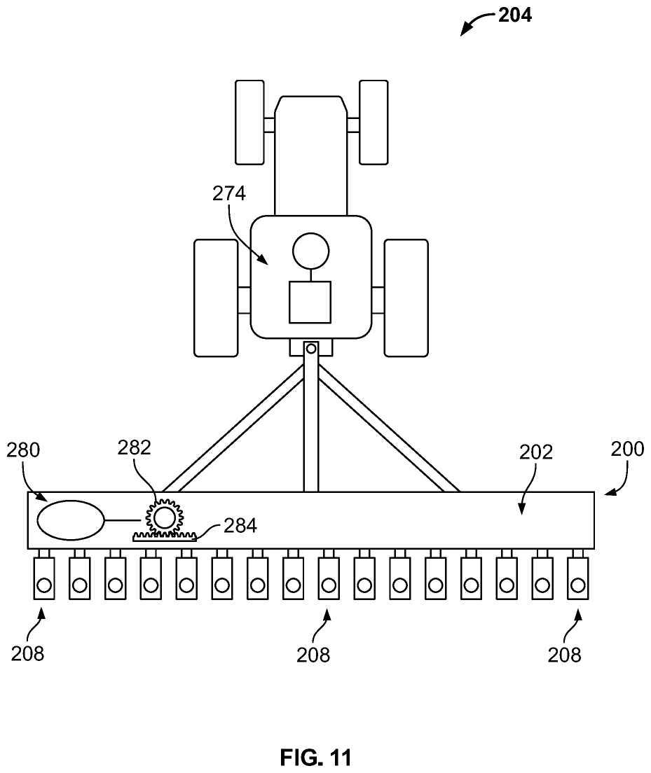

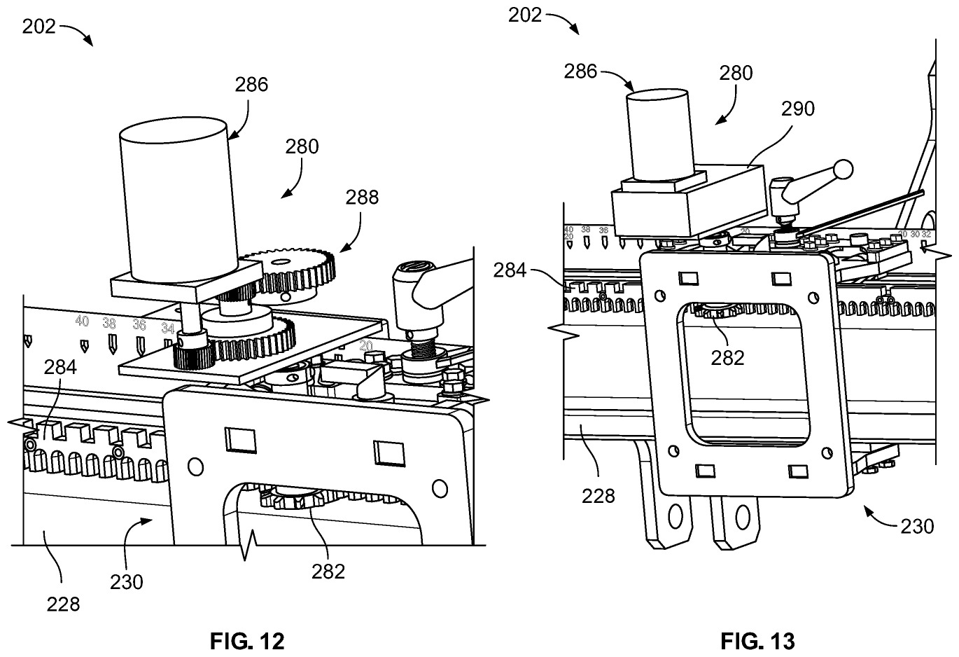

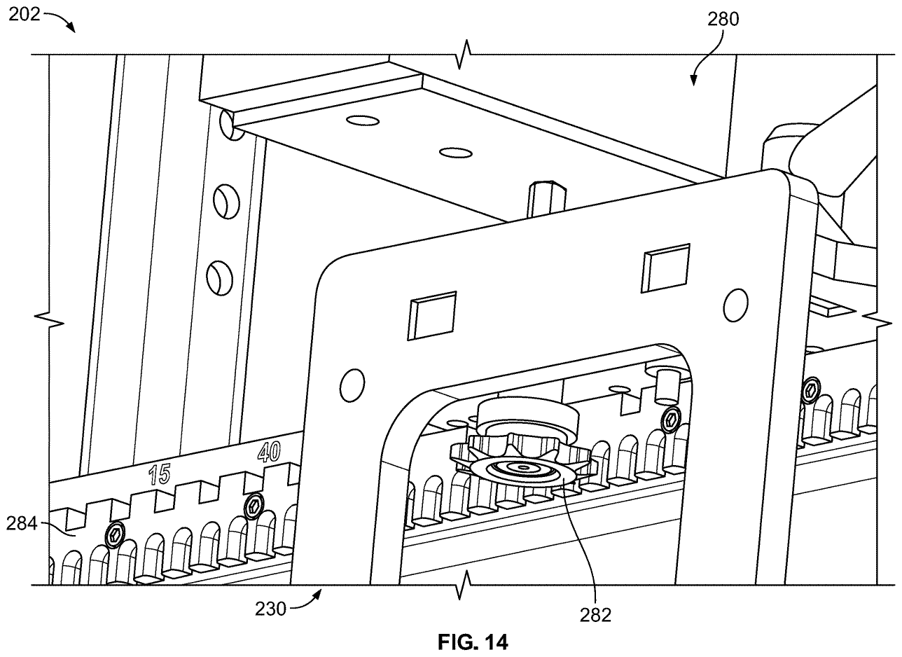

In the illustrated embodiment, the support 144 of the tool bar assembly 102 includes a rack configuration, for example, having multiple teeth 162 formed therein. The teeth 162, then, are configured to mate with corresponding protrusions of a pinion associated with drive means (e.g., a motor (e.g., drive mechanism 280 of FIGS. 11-14, etc.), a crank, etc.) for use in moving the planting unit along the tool bar 128.

The support 144 of the tool bar assembly 102 also includes multiple openings 164 (e.g., notches, etc.) formed along (e.g., spaced apart along, etc.) an upper surface thereof, corresponding to particular (e.g., desired, predetermined, etc.) positions of the planting units 108 along the tool bar 128. In addition, the support 144 also includes a measurement indicator 165 providing measurement readings at each of the openings 164 to thereby provide identification of the particular spacing of planting units 108 relative to each other when positioned at the given opening(s) 164. In connection therewith, each of the carriers 130 includes a latch 166 (e.g., a pin, etc.) configured to be positioned in one of the openings 164 of the support 144, corresponding to a desired position of the given planting unit 108 along the tool bar 128. A locking mechanism 168 (e.g., a screw mechanism, a ratchet mechanism, etc.) (broadly, a lock) of the carrier 130 may then be actuated to secure (e.g., via friction, etc.) the planting unit 108 on the tool bar 128 in the desired position. For instance, in the illustrated embodiment, the locking mechanism 168 includes a handle 169 (and corresponding lock 171) configured to actuate a bearing 173 that is then configured to engage the upper track 136 of the tool bar 128 to thereby secure the carrier 130 and corresponding planting unit 108 in place along the tool bar 128. That said, it should be appreciated that the support 144 may not include the openings 164 in other embodiments, and/or may not include the measurement indicator 165.

In addition in the illustrated embodiment, end portions 170 (e.g., wings, etc.) of the tool bar 128 are hinged (at hinge points 170) to allow for pivoting movement of the end portions 170 of the tool bar 128 relative to the frame 106 of the planter 100. In particular, in connection with use of the hinge points 170, the planting units 108 may be positioned along the tool bar 128 generally inward of the hinge points 170 of the tool bar 128, and the end portions 170 of the tool bar 128 may then be folded relative to the frame 106 to a width such that it can travel on conventional roads, etc. In connection therewith, the insert 142 and the support 144 are uniquely formed to allow for, and to accommodate, such pivoting movement. For instance, end portions of the insert 142 and end portions of the support 144, at the hinge points 170, are generally angled or tapered to allow for the pivoting movement (without buckling, or engaging). That said, it should be appreciated that such adjustability of the tool bar 128 and/or the insert 142 is not required in all embodiments.

With reference again to FIG. 1, a control system 174 is provided in communication with the planter 100 and the planting units 108 thereof, and is configured to control one or more operations of the planter 100 (and/or the tractor 104) described herein (e.g., such that in some embodiments the planter 100 may be fully automated, may operate without human intervention, etc.). In the illustrated embodiment, the control system 174 is disposed in the tractor 104. However, in other embodiments, the control system 174 may be located otherwise, for example, on the planter 100, remote from the planter 100 and tractor 104 (for remote operation thereof), etc. In connection therewith, the control system 174 may include (and/or may be associated with) a global positioning system (GPS) receiver 176, whereby the control system 174 and the GPS receiver 176 may be configured to control operation of the tractor 104 to move through the field/plot (e.g., to move through the field/plot along a desired path, to move to desired locations in the field/plot, etc.), and to control operation of the planting units 108 of the planter 100 to plant seeds in the field/plot (e.g., to plant desired seeds in the field/plot, to plant desired seeds in desired locations in the field/plot, to transition between different seeds stored onboard the planter 100 to effect such planting on the fly, to plant seeds at a desired rate (and/or change the rate on the fly), to plant seeds at a desired row spacing (and/or change the row spacing on the fly by adjusting positions of the planting units 108 on the frame 106 (via communication with the tool bar assembly 102)), etc.). With that said, it should be appreciated that the planter 100 may be fully automated in various embodiments, as described above. However, in other embodiments, the planter 100 may be utilized with manual operations while still implementing one or more of the features described herein.

FIGS. 11-14 illustrate another example embodiment of an agricultural implement 200 coupled to tractor 204. In connection therewith, the agricultural implement 200 includes multiple row units 208 coupled to tool bar assembly 202. The tool bar assembly 202, then, is configured to allow for adjustment of a relative spacing between the row units 208 in substantially the same manner as described above. To this point, the tool bar assembly 202 is substantially the same as the tool bar assembly 102 described above, whereby the description of the tool bar assembly 102 applies to the tool bar assembly 202. In this embodiment, the row units 208 may include, for example, planting units (e.g., similar to planting units 108, etc.), sprayer units, tilling units, imaging units, other units configured to be arranged in rows on a tool bar, etc.

In addition in this embodiment, the agricultural implement 200 includes a drive mechanism 280 configured to drive a pinion 282 associated with the row units 208 via a carrier 230 (e.g., similar to carrier 130, etc.) coupled to the row units 208, etc. for engaging (e.g., via tines of the pinion 282, etc.) a rack portion 284 of the tool bar assembly 202 (e.g., teeth of the rack portion 284 such as the teeth 162 of the support 144, etc.) for driving movement of the row units 208 (via the carrier 230) relative to each other (and relative to the tool bar assembly 202 (e.g., relative to tool bar 228 of the tool bar assembly 202, etc.), etc.). In addition, in the illustrated embodiment, the drive mechanism 280 is coupled to the carrier 230 and includes a motor 286 (e.g., an electric motor in communication with control system 274, etc.) and gears 288 (housed in box 290) configured to interact with pinion 282 (e.g., via drive shaft, etc.), to drive the pinion 282 and move the row units 208 as described herein. In doing so, in this embodiment, the motor 286 is configured to move with the carrier 230 along the tool bar 228 as it moves the carrier 230 (and corresponding row unit 208). In other embodiments, the drive mechanism 280 may include a manual handle/crank, etc.

In some example embodiments, the tool bar assemblies of the present disclosure may be used to upgrade or update an existing tool bar of an agricultural implement (e.g., as a retrofit to update or upgrade the tool bar with components that can be replaced if/when worn out, etc.). In connection therewith, the tool bar assemblies may be provided as part of a kit for use in effecting the upgrade or update. In one example, such a kit may include an insert (e.g., insert 142, etc.) configured to removably couple to a tool bar (e.g., tool bar 128, etc.) of the agricultural implement within a channel of the tool bar (e.g., within channels 140 of the upper and track 134 of the tool bar 128, etc.) and along a sidewall thereof (e.g., along sidewall 146, etc.). The kit may also include a support (e.g., support 144, etc.) configured to removeably couple to the tool bar outside of the channel, along the sidewall of the tool bar, in a position generally opposing the insert and with the sidewall of the rail generally between the insert and the support. Further, the kit may include a bearing plate (e.g., bearing plate 158, etc.) configured to couple to an upper portion of a carrier (e.g., the upper member 150 of the carrier 130, etc.) of the agricultural implement, wherein the carrier is configured to couple a row unit of the agricultural implement to the rail.

The foregoing description of the embodiments has been provided for purposes of illustration and description. It is not intended to be exhaustive or to limit the invention.

Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments have been provided so that this disclosure will be thorough, and will fully convey the scope to those who are skilled in the art. Numerous specific details are set forth such as examples of specific components, assemblies, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, components, and/or groups thereof, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element, component, seed, member or section discussed below could be termed a second element, component, seed, member or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A tool bar assembly for an agricultural implement, the tool bar assembly comprising:
a carrier configured to couple to a row unit of an agricultural implement;
a rail defining a channel configured to receive the carrier and guide movement of the carrier along the rail;
an insert removably coupled to the rail within the channel of the rail; and
a support removeably coupled to the rail outside of the channel in a position generally opposing the insert.

2. The tool bar assembly of claim 1, further comprising at least one fastener configured to extend through a sidewall of the rail to couple the insert to the support, wherein the sidewall is positioned generally between the insert and the support.

3. The tool bar assembly of claim 1, wherein the carrier includes a roller configured to position within the channel against the insert, when the carrier is received by channel.

4. The tool bar assembly of claim 3, wherein the roller of the carrier is configured to engage an upper surface of the insert, when the carrier is received by the channel.

5. The tool bar assembly of claim 3, wherein the channel of the rail is a first channel, wherein the roller of the carrier is first roller, and wherein the rail further defines a second channel; and
wherein the carrier further includes a second roller configured to position within the second channel, when the carrier is received by the channel.

6. The tool bar assembly of claim 5, wherein a width of the first channel is less than a width of the second channel.

7. The tool bar assembly of claim 5, wherein the first roller is a vertical roller and wherein the second roller is a horizontal roller.

8. The tool bar assembly of claim 5, wherein the first channel is disposed along an upper surface of the rail and wherein the second channel is disposed along a lower surface of the rail.

9. The tool bar assembly of claim 1, wherein the support includes multiple openings defined along an upper surface of the support; and
wherein the carrier includes a positioning latch configured to position within at least one of the openings when the carrier is received by the channel of the rail to thereby locate the carrier along the rail in a position corresponding to the at least one of the openings.

10. The tool bar assembly of claim 1, wherein the carrier includes a lock configured to secure the carrier to the rail.

11. The tool bar assembly of claim 1, further comprising a drive mechanism coupled to the carrier, the drive mechanism configured to move the carrier along the rail.

12. The tool bar assembly of claim 11, wherein the drive mechanism includes an electric motor.

13. The tool bar assembly of claim 12, wherein the electric motor is disposed generally above the carrier and is configured to move with the carrier along the rail.

14. The tool bar assembly of claim 1, wherein the agricultural implement is a planter.

15. An agricultural implement comprising the tool bar assembly of claim 1.

16. A method of retrofitting a tool bar of an agricultural implement, the method comprising:
positioning an insert within a channel of a rail of the tool bar of the agricultural implement, along a sidewall of the rail;
positioning a support along the sidewall of the rail, in a position outside of the channel and generally opposing the insert so that the sidewall of the rail is positioned generally between the insert and the support; and
coupling the insert to the support.

17. The method of claim 16, wherein coupling the insert to the support includes coupling the insert to the support using at least one fastener extending through the sidewall of the rail

18. A kit for use in retrofitting a tool bar of an agricultural implement, the kit comprising:
an insert configured to removably couple to a rail of the agricultural implement within a channel of the rail and along a sidewall of the rail; and
a support configured to removeably couple to the rail outside of the channel, along the sidewall of the rail, in a position generally opposing the insert and with the sidewall of the rail generally between the insert and the support.

19. The kit of claim 18, further comprising a bearing plate configured to couple to an upper portion of a carrier of the agricultural implement, wherein the bearing plate includes at least one vertical roller, and whereby the carrier is configured to couple a row unit of the agricultural implement to the rail.

20. The kit of claim 19, further comprising a drive mechanism configured to couple to the carrier of the agricultural implement, and wherein the drive mechanism is configured to move the carrier and row unit of the agricultural implement along the rail.
